(19) United States
(12) Patent Application Publication
(10) Pub. No.: US 2019/0323356 A1
(43) Pub. Date: Oct. 24, 2019

(54) COMPRESSOR BLADE SURFACE PATTERNING

(71) Applicant: Dyson Technology Limited, Wiltshire (GB)

(72) Inventors: Qiang LIU, Manchester (GB); Shan ZHONG, Manchester (GB); Mark Andrew JOHNSON, Bath (GB); Matthieu Michel Xavier DE MAILLARD, Bristol (GB)

(73) Assignee: Dyson Technology Limited, Wiltshire (GB)

(21) Appl. No.: 16/462,327

(22) PCT Filed: Nov. 17, 2017
(86) PCT No.: PCT/GB2017/053458

§ 371 Date: May 20, 2019

(30) Foreign Application Priority Data
Nov. 21, 2016 (GB) 1619666.9

(51) Int. Cl. F01D 5/14; B64C 21/10; F04D 29/32; F04D 29/38; F04D 29/68; F15D 1/00; F15D 1/12

(52) U.S. Cl. CPC F01D 5/145; B64C 21/10; F04D 29/324; F04D 29/388; F05D 2250/75; F15D 1/0035; F15D 1/12; F05D 2250/294; F05D 2250/183; F04D 29/68

(57) ABSTRACT

A compressor blade having a leading edge and a trailing edge, and a surface pattern between the leading and trailing edges, the surface pattern comprising at least one set of herringbone riblets formed of a plurality of v-shaped riblets, wherein the v-shaped riblets are spaced apart by a distance of between 200-400 μm, and have a height of between 50-120 μm.

### REFERENCE TO RELATED APPLICATIONS

This application is a national stage application under 35 USC 371 of International Application No. PCT/GB2017/053458, filed Nov. 17, 2017, which claims the priority of United Kingdom Application No. 1619666.9, filed Nov. 21, 2016, the entire contents of each of which are incorporated herein by reference.

### FIELD OF THE INVENTION

The present invention relates to surface patterning on compressor blades.

### BACKGROUND OF THE INVENTION

Driven by the need to decrease blade count so as to reduce the overall component weight, axial compressor blades are designed to bear high loading and hence are prone to flow separation, especially at off-design operating conditions. The advancement towards ever higher blade loading gives rise to a need to control the flow since it is susceptible to strong adverse pressure gradients after the suction peak, and in many cases can be followed by a stall. Furthermore, for compressors working at low Reynolds numbers, laminar boundary layer separation on the suction surface of blade typically increases, causing deterioration in performance.

In order to control boundary layer separation, both passive and active methods have been previously explored to reduce or overcome the effects of separation in axial compressors. Some examples of active methods previously explored include using steady and pulsed air jets to control the separation on the suction surface, using acoustic excitation, or plasma actuators. Examples of known passive flow control devices are vane and plow vortex generators, use of a cavity to control shock wave interactions with a turbulent boundary layer, and low profile vortex generators to reduce the boundary layer thickness.

Depending on the type, passive devices can either trigger boundary layer transition before separation starts, thus completely avoiding separation, or they introduce flow instabilities that anticipate transition in the separated shear layer thus decreasing bubble size.

Passive control methods remain the preferable techniques because of their simplicity and cost effectiveness. However, a significant drawback with passive devices is the high profile losses they give rise to at higher Reynolds numbers.

### SUMMARY OF THE INVENTION

A first aspect of the present invention provides a compressor blade having a leading edge and a trailing edge, and a surface pattern between the leading and trailing edges, the surface pattern comprising at least one set of herringbone riblets formed of a plurality of v-shaped riblets, wherein the v-shaped riblets are spaced apart by a distance of between 200-400 μm, and have a height of between 50-120 μm.

As a result, the compressor blade is less susceptible to the effects of boundary layer separation, particularly at low Reynolds numbers, and total pressure loss can be reduced in a highly loaded compressor cascade which comprises the compressor blades.

The at least one set of herringbone riblets may be positioned such that an upstream end of the set of herringbone riblets is located within a boundary layer separation bubble for the blade.

The at least one set of herringbone riblets may be positioned such that an upstream end of the set of herringbone riblets is located between 24% and 46% of a total chord length of the blade from the leading edge, and may be positioned such that an upstream end of the set of herringbone riblets is located at 37% of the total chord length of the blade from the leading edge.

A downstream end of the at least one set of herringbone riblets may be located at the trailing edge of the blade. Alternatively the downstream end of the at least one set of herringbone riblets may be located between 5% to 20% of a total chord length of the blade from the trailing edge, and may be located at 10% of a total chord length of the blade from the trailing edge.

An angle formed by each of the v-shaped riblets may be between 40° and 80°, and may be 60°.

The v-shaped riblets may be spaced apart by a distance of 300 μm, and the v-shaped riblets may have a height of 80 μm.

The compressor blade may be one of a diffuser blade and an impeller blade.

The surface pattern may be etched onto a surface of the blade using a laser.

The surface pattern may be provided in an adhesive strip adhered to a surface of the blade.

A second aspect of the present invention provides an adhesive strip comprising a surface pattern engraved therein comprising at least one set of herringbone riblets formed of a plurality of v-shaped riblets, wherein the v-shaped riblets are spaced apart by a distance of between 200-400 μm, and have a height of between 50-120 μm.

The adhesive strip may be formed of polyvinyl chloride (PVC), or the adhesive strip may be formed of a metallic foil.

The surface pattern may be formed by laser etching.

A third aspect of the present invention provides a method of applying a surface pattern to a compressor blade, the method comprising first forming the surface pattern in an adhesive strip, and then adhering the adhesive strip to the compressor blade.

### BRIEF DESCRIPTION OF THE DRAWINGS

In order that the present invention may be more readily understood, embodiments of the invention will now be described, by way of example, with reference to the following accompanying drawings, in which:

FIG. 1 is a schematic representation of a compressor blade cascade testing apparatus;

FIG. 2 shows a schematic representation of part of a blade cascade;

FIG. 3 shows a compressor blade;

FIG. 4 shows the compressor blade of FIG. 3 with a surface pattern;

FIG. 5 shows a set of herringbone riblets;

FIG. 6 shows a cross section through two riblets; and

FIGS. 7A and 7B show adhesive strips having a number of sets of herringbone riblets formed therein.

### DETAILED DESCRIPTION OF THE INVENTION

As will now be described, and as shown in the figures, a novel herringbone riblets pattern has been found to be effective in reducing the total pressure loss in a highly loaded compressor cascade.

The following terminology is referred to herein using the corresponding symbols as shorthand:

α Incidence angle
β Blade angle
p Pitch length
c Chord length
c′ Axial chord length in local coordinate system
Re Reynolds number
ξ₁ Pitch to chord ratio
ξ₂ Aspect ratio
sₚ Span length
LE Leading edge
TE Trailing edge
LSL Laminar separation line
RL Reattachment line
s Riblet groove width
h Riblet groove depth
θ Riblet divergent angle
lᵣ Ribleted strip length
bᵣ Ribleted strip width

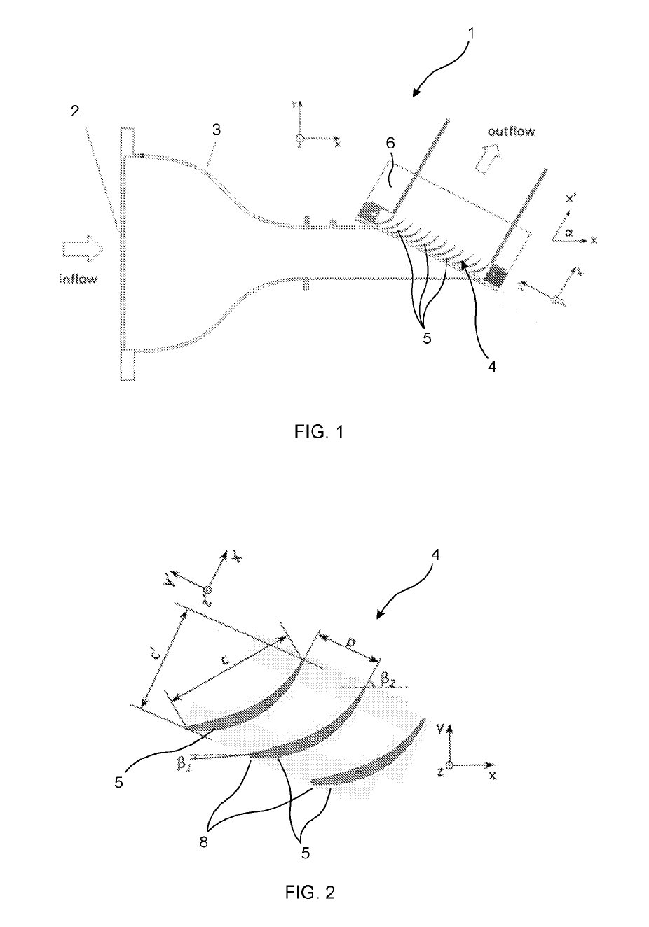

FIG. 1 shows a schematic representation of a testing apparatus 1. An airflow generator (not shown) in the form of a centrifugal fan driven by a motor, is provided upstream of a turbulence grid 2. The turbulence grid 2 allows for an adjustable turbulence level such that the flow characteristics of the airflow acting on the blades 5 can be adjusted. Downstream of the turbulence grid 2, is a contract section 3 in which the flow is accelerated. The blade cascade 4 is shown downstream of the contract section 3, and the blade cascade 4 is fitted to a tailboard 6 which allows for easy access, removal and replacement of the blade cascade 4. The testing apparatus 1 is intended to provide a maximum flow speed of 120 m/s across the blade cascade 4, corresponding to a maximum Reynolds number around 3×105. The blade cascades explored in the present application are intended to be operable at relatively low Reynolds numbers in the range 5×104 to 2×105. This range of Reynolds number is considered to be low for high-speed compressors of the type typically found in turbo machinery such as turbochargers or high-speed compressors. For example, a turbocharger would typically work at a Reynolds number of around 5×105 to 1×106.

FIG. 2 shows a schematic representation of part of the blade cascade 4 shown in FIG. 1. The cascade is made up of 13 blades 5, forming 12 passages in the testing apparatus. However, only three blades 5 are shown in FIG. 2. The blades 5 have a highly loaded profile, characterised by a chord length (c) of 31 mm and a height (span, sₚ) of 51.2 mm to ensure two-dimensional flow at midspan. The maximum thickness is 2.5 mm at 34% chord length from the leading edge (LE) 8. The turning angle of the blade 5 is 60.3°. The blades 5 in the blade cascade 4 in the testing apparatus 1 can rotate with respect to the incoming flow direction in order to allow variation of the incidence angle within the range −10 deg<α<+10 deg. The main geometrical parameters of the blade profiles are summarized in Table 1.

TABLE 1

| Reynolds number (Re) | 1 × 10⁵ |
|---|---|
| True Chord length (c) | 31.0 mm |
| Axial chord length (c′) | 26.1 mm |
| Pitch (p) | 15.9 mm |
| Pitch to chord ratio (ξ₁) | 0.513 |
| Span (sₚ) | 51.2 mm |
| Aspect ratio (ξ₂) | 1.65 |
| Inlet blade angle (β₁) | 0.83° |
| Exit blade angle (β₂) | 61.1° |

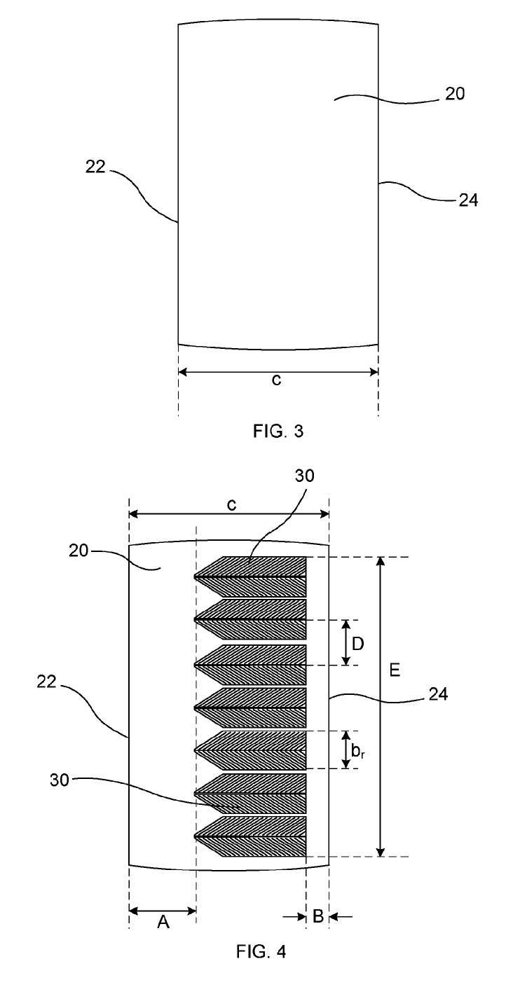

FIG. 3 shows a compressor blade 20. This compressor blade 20 may be of the type used in a diffuser of a compressor, or could be an impeller blade, for example on an axial impeller, The blades 5 in the testing apparatus of FIG. 1 are analogous to the compressor blade 20, and the testing apparatus 1 is intended to carry out experimentation to find optimal geometric parameters for blades in a compressor. The blade 20 is therefore typical of a blade shape that may be used, for example, in high speed axial compressors. The blade 20 has a leading edge (LE) 22 at an upstream side of the blade, and a trailing edge (TE) 24 at a downstream side of the blade. The distance between the LE 22 and the TE 24 is known as the chord length, shown as dimension c.

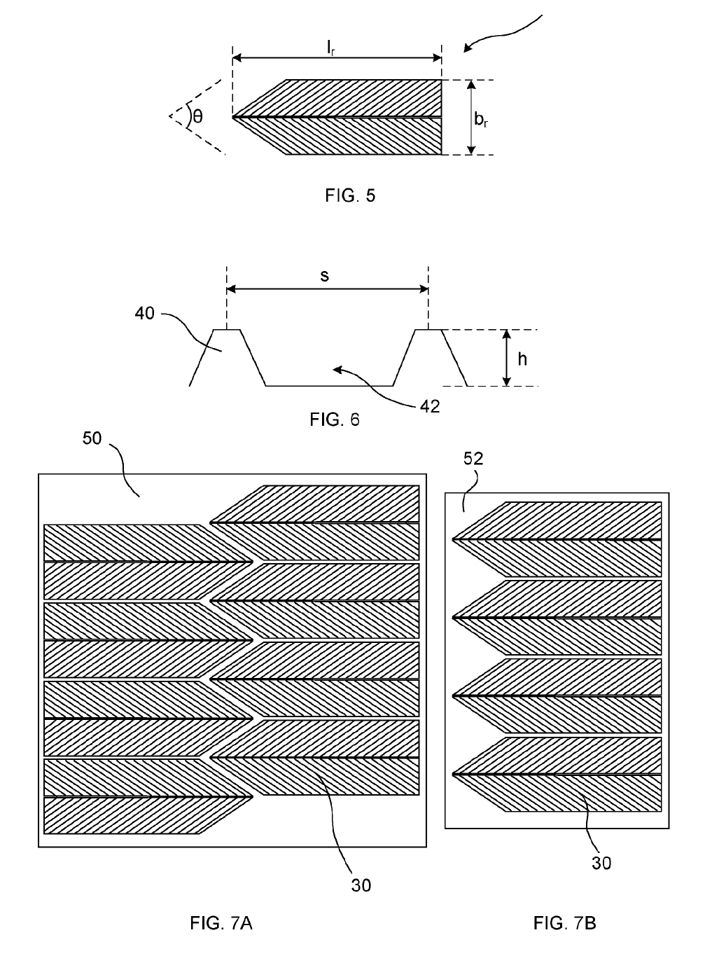

FIG. 4 shows the blade 20 of FIG. 3, but with a surface pattern modification. The surface pattern modification is in the form of a number of sets of herringbone riblets 30. The blade 20 in FIG. 4 has seven sets of herringbone riblets 30 on the convex upper surface of the blade 20. One set of herringbone riblets is shown in FIG. 5. A magnified cross section through two adjacent riblet peaks is shown in FIG. 6.

Experimentation carried out by the inventors found that on a compressor blade such as blade 20, the laminar boundary layer of flow over the blade surface separates at the laminar separation line, LSL, which is around 24% of the chord length (24% c) from the LE and re-attaches at the reattachment line, RL, at around 46% chord length (46% c). Accordingly, in order to reduce boundary layer separation on blade 20, the sets of herringbone riblets are positioned on the blade surface such that the start of the riblets, i.e. the upstream end of the riblets, is located in the separation bubble. The riblets in FIG. 4 start at 37% c from the LE 22. The herringbone riblets end, i.e. the downstream end, close to the trailing edge (TE) 24, and in the blade 20 in FIG. 4, the riblets end at 90% c from the LE 24 (i.e. 10% c from the TE 24). The riblets could end at the TE 24, but it has been found to be beneficial for the riblets to end close to, but a small distance from, the TE 24.

When the blade 20 with herringbone riblets is placed in a blade cascade, and used in test equipment such as that shown in FIG. 1, it has been found that the pressure distribution following the blade cascade is far more uniform than when a cascade is used having blades without the herringbone riblets. In addition, the average total pressure loss coefficient is also decreased by 22.4% when blades having the herringbone riblets are used. Furthermore, the velocity vectors following the blade cascade are distributed more uniformly with an average flow turning angle being increased by 10 degrees. Accordingly, a profound aerodynamic improvement is produced due to the use of herringbone riblets.

The length of a set of riblets, lr, is dependent on the total chord length c of the blade 20. Typically lᵣ will be around 66% to 44% of the total chord length c. For a blade having a chord length c of 31 mm, lᵣ will be around 13 mm to 20 mm, and preferably between 16 mm and 18 mm. For the same size blade, the width of a set of riblets, bᵣ, is around 4-10 mm, and in a preferred embodiment is 6 mm. A set of riblets 30 is formed of a plurality of alternating V-shaped riblets 40 and grooves 42. The angle θ between the two arms of the v-shape of the riblets 40 and grooves 42 is 60°, with each arm extending at an angle of 30° from a centre line through the middle of each set of riblets 30. In the preferred embodiment, as shown in FIGS. 4, 5 and 6, the riblets 40 are spaced apart by a distance, s, of between 200-400 μm, preferably 300 μm, and each riblet has a height, h, of between 50-120 μm, preferably 80 um. However it will be appreciated that the values of s and h may vary according to the specifications and requirements of the blade, and the working parameters of the compressor.

Sets of riblets 30 may be positioned adjacent one another on a blade surface such that there is no gap between them. However, a gap of between 0.2 mm and 1 mm between two adjacent sets of riblets 30 has been found to be beneficial. A particularly preferred embodiment has a gap of 0.5 mm between adjacent sets of riblets 30.

Accordingly, for a particularly preferred embodiment on a blade having a chord length c of 31.0 mm, the dimensions referenced in FIGS. 4, 5 and 6 are set out in the table 2 below.

TABLE 2

| | | |
|---|---|---|
| c | 31.0 | mm |
| A | 11.47 | mm |
| B | 3.1 | mm |
| D | 6.5 | mm |
| E | 45 | mm |
| s | 300 | μm |
| h | 80 | μm |
| lᵣ | 18 | mm |
| bᵣ | 6 | mm |

| | |
|---|---|
| θ | 60° |

Each set of herringbone riblets 30 can be formed by directly engraving grooves into the blade surface using a laser. Laser etching/engraving is the preferred method for creating the riblets due to the high level of flexibility, as well as easy and accurate controllability that it provides.

However, laser etching/engraving directly onto the blade surface can prove difficult, particularly when the blade forms part of a larger component, for example if it is a blade in a diffuser or impeller. It may be that it is difficult or impossible to angle the laser to achieve the desired pattern in the correct position on the blade. For example, the laser lens may be immovable in a vertical direction, which would mean that the working spot for the laser is only able to move in a horizontal plane during the manufacturing process. An accurate 3D control device that is capable of laser engraving on a curved surface on a blade would be required, and the cost of such a control device could be prohibitively expensive.

An alternative method is to manufacture sets of herringbone riblets 30 on adhesive tape as adhesive strips, as shown in FIGS. 7A and 7B, which can be adhered to a blade surface in the desired position. A laser can still be used to create the riblets in the adhesive tape, but due to the planar nature of the tape, the manufacturing process is made far easier than using the laser directly on the blade surface. The required number of sets of riblets 30 may be formed as a single adhesive strip on a piece of adhesive tape which is then adhered as one piece onto a blade surface. Alternatively individually removable sets of riblets 30 may be produced as individual adhesive strips of adhesive tape. Then, each set of riblets can be taken from the strip and positioned as required on the blade surface. FIG. 7A shows a strip of adhesive tape 50 comprising eight sets of herringbone riblets arranged in an overlapping formation for greater space efficiency, and FIG. 7B shows a narrower strip of adhesive tape 52 having a single line of four sets of herringbone riblets 30.

The adhesive tape may be formed of a polyvinyl chloride (PVC), for example similar to packing tape (otherwise known as parcel tape) or electrical insulation tape. In an alternative embodiment, the adhesive tape may be formed of a thin metallic foil. Herringbone riblets formed using adhesive metallic foil has been found to produce the best results for reducing boundary layer separation provided the riblets remain in perfect shape. However, foil is easily crinkled, and the riblets formed in the foil can become misshapen during application to the blade surface if not handles with extreme care. This can lead to a reduction in the riblets' effectiveness. Adhesive PVC tape on the other hand, whilst not achieving the same high level of results in reducing boundary layer separation as foil, is still very effective but does not suffer from the same crinkling problem that foil does, and so can provide a better option for a typical manufacturing process.

Whilst particular embodiments have thus far been described, it will be understood that various modifications may be made without departing from the scope of the invention as defined by the claims.

1. A compressor blade having a leading edge and a trailing edge, and a surface pattern between the leading and trailing edges, the surface pattern comprising at least one set of herringbone riblets formed of a plurality of v-shaped riblets, wherein the v-shaped riblets are spaced apart by a distance of between 200-400 μm, and have a height of between 50-120 μm.

2. The compressor blade of claim 1, wherein the at least one set of herringbone riblets is positioned such that an upstream end of the set of herringbone riblets is located within a boundary layer separation bubble for the blade.

3. The compressor blade of claim 1, wherein the at least one set of herringbone riblets is positioned such that an upstream end of the set of herringbone riblets is located between 24% and 46% of a total chord length of the blade from the leading edge.

4. The compressor blade of claim 3, wherein the at least one set of herringbone riblets is positioned such that the upstream end of the set of herringbone riblets is located at 37% of the total chord length of the blade from the leading edge.

5. The compressor blade of claim 1, wherein a downstream end of the at least one set of herringbone riblets is located at the trailing edge of the blade.

6. The compressor blade of claim 1, wherein a downstream end of the at least one set of herringbone riblets is located between 5% and 20% of a total chord length of the blade from the trailing edge.

7. The compressor blade of claim 6, wherein the downstream end of the at least one set of herringbone riblets is located at 10% of a total chord length of the blade from the trailing edge.

8. The compressor blade of claim 1, wherein an angle formed by each of the v-shaped riblets is between 40° and 80°.

9. The compressor blade of claim 8, wherein the angle formed by each of the v-shaped riblets is 60°.

10. The compressor blade of claim 1, wherein the v-shaped riblets are spaced apart by a distance of 300 μm.

11. The compressor blade of claim 1, wherein the v-shaped riblets have a height of 80 μm.

12. The compressor blade of claim 1, wherein the compressor blade is one of a diffuser blade and an impeller blade.

13. The compressor blade of claim 1, wherein the surface pattern is etched onto a surface of the blade using a laser.

14. The compressor blade of claim 1, wherein the surface pattern is provided in an adhesive strip adhered to a surface of the blade.

15. An adhesive strip comprising a surface pattern engraved therein comprising at least one set of herringbone riblets formed of a plurality of v-shaped riblets, wherein the v-shaped riblets are spaced apart by a distance of between 200-400 μm, and have a height of between 50-120 μm.

16. The adhesive strip of claim 15, wherein an angle formed by each of the v-shaped riblets is between 40° and 80°.

17. The adhesive strip of claim 16, wherein the angle formed by each of the v-shaped riblets is 60°.

18. The adhesive strip of claim 15, wherein the v-shaped riblets are spaced apart by a distance of 300 μm.

19. The adhesive strip of claim 15, wherein the v-shaped riblets have a height of 80 μm.

20. The adhesive strip of claim 15, wherein the adhesive strip is formed of polyvinyl chloride (PVC).

21. The adhesive strip of claim 15, wherein the adhesive strip is formed of a metallic foil.

22. The adhesive strip of claim 15, wherein the surface pattern is formed by laser etching.

23. A method of applying a surface pattern to a compressor blade, the method comprising first forming the surface pattern in an adhesive strip, and then adhering the adhesive strip to the compressor blade.
